(19) United States
(12) Patent Application Publication
(10) Pub. No.: US 2026/0343396 A1
(43) Pub. Date: Oct. 29, 2026

(54) ENHANCED METHODS FOR ESTABLISHING USER EQUIPMENT (UE) POLICY ASSOCIATION

(71) Applicant: LENOVO (SINGAPORE) PTE. LTD., Singapore (SG)

(72) Inventors: Roozbeh Atarius, La Jolla, CA (US); Genadi Velev, Darmstadt (DE)

(73) Assignee: LENOVO (SINGAPORE) PTE. LTD., Singapore (SG)

(21) Appl. No.: 19/483,866

(22) PCT Filed: May 8, 2024
(86) PCT No.: PCT/IB2024/054504

§ 371 Date: Nov. 12, 2025

Related U.S. Application Data
(60) Provisional application No. 63/501,639, filed on May 11, 2023.

(51) Int. Cl. H04W 48/18; H04W 40/24; H04W 48/16

(52) U.S. Cl. CPC H04W 48/18; H04W 40/246; H04W 48/16

(57) ABSTRACT

Various aspects of the present disclosure relate to an apparatus for enhanced methods for establishing user equipment (UE) policy association. An apparatus (e.g. UE) transmits, to a first network entity, a first signaling indicating an attach request. The apparatus receives a second signaling in response to transmitting the first signaling. The second signaling including an indication of a list of identities of network entities capable of processing extended protocol configuration options (ePCO) information elements (IEs). The apparatus performs a procedure by transmitting an ePCO information element (IE) to a second network entity via one or more of the network entities identified in the list of identities.

### RELATED APPLICATION

This application claims priority to U.S. Provisional Application Ser. No. 63/501,639 filed May 11, 2023 entitled “ENHANCED METHODS FOR ESTABLISHING UE POLICY ASSOCIATION,” the disclosure of which is incorporated by reference herein in its entirety.

### TECHNICAL FIELD

The present disclosure relates to wireless communications, and more specifically to user equipment (UE) policy association.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as UE, or other suitable terminology. The wireless communications system may support wireless communications with one or multiple user communication devices by utilizing resources of the wireless communications system, such as time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In radio access networks, policy management for access and mobility may include policy control for session management and service data flow, e.g., for controlling quality-of-service (QoS), gating, etc.

### SUMMARY

The present disclosure relates to methods, apparatuses, and systems that support enhanced methods for establishing UE policy association. By utilizing the described techniques, a UE is configured to trigger UE policy association in a configuration where an initial attach request from the UE to a first network entity (e.g., mobility management entity (MME)) that does not support processing extended protocol configuration options (ePCO) information elements (IEs). In an example, if ePCO is not supported by a MME and/or a serving gateway (SGW) handling the attach request, the UE sends a protocol configuration options (PCO) information element (IE) that indicates that the UE supports UE route selection policy (URSP). In response, a second network entity (e.g., session and mobility management function packet data network gateway controller (SM+PGW-C)) transmits to the UE a list of MME identities that are capable of processing ePCO IEs. The UE then indicates at least one identity from the list of MME identities to a base station (e.g., eNB), to facilitate re-attaching the UE to the network via another MME that supports processing ePCO IEs, thereby allowing the UE to trigger UE policy association (e.g., during a tracking update procedure) by sending an ePCO IE. By sending the PCO IE indicating that the UE supports URSP, the UE is able to trigger UE policy association with a SM+PGW-C in systems were an initial attach request (e.g., including an ePCO IE for triggering the UE policy association) from the UE is routed to the SM+PGW-C via a MME that does not support processing ePCO IEs.

In some implementations of the method and apparatuses described herein, a UE transmits, to a first network entity, a first signaling indicating an attach request; receives a second signaling in response to transmitting the first signaling, the second signaling including an indication of a list of identities of network entities capable of processing ePCO IEs; and performs a procedure by transmitting an ePCO IE to a second network entity via one or more of the network entities identified in the list of identities.

Some implementations of the method and apparatuses described herein may further include the UE uses a parameter in a radio resource control (RRC) message to indicate at least one identity from the list of identities for performing the procedure. Additionally or alternatively, the second signaling includes the indication of the list of identities based on the first network entity being incapable of processing ePCO IEs. Additionally or alternatively, the second signaling is received from the second network entity via the first network entity. Additionally or alternatively, the ePCO IE includes a message, the message including one or more IEs for triggering a policy association. Additionally or alternatively, the attach request includes a PCO IE, the PCO IE including a container having an identity, the identity indicating that the apparatus is capable of receiving URSP in an evolved packet system (EPS) network. Additionally or alternatively, the second signaling includes a PCO IE from the second network entity, the PCO IE including a container indicating the list of identities. Additionally or alternatively, the procedure is a tracking area update procedure. Additionally or alternatively, the first network entity is a MME. Additionally or alternatively, the second network entity is a SM+PGW-C. Additionally or alternatively, the list of identities includes identities of one or more mobility management entities capable of processing the ePCO IEs.

In some implementations of the method and apparatuses described herein, a MME receives, from a UE, a first signaling indicating an attach request; transmits, to a network entity, a second signaling as a create session request message based on the attach request; and receives, from the network entity, a third signaling that includes an indication of a list of identities of network entities capable of processing extended policy configuration options (ePCO) IEs; and transmits, for receipt at the UE, a fourth signaling indicating the list of identities.

Some implementations of the method and apparatuses described herein may further include the third signaling includes the indication of the list of identities based on the apparatus being incapable of processing ePCO IEs. Additionally or alternatively, the attach request includes an ePCO IE, the ePCO IE including a message, the message including one or more IEs for triggering a policy association. Additionally or alternatively, the attach request includes a PCO IE, the PCO IE including a container having an identity, the identity indicating that the UE is capable of receiving URSP in an EPS. Additionally or alternatively, the create session request message includes the PCO IE and excludes the ePCO IE. Additionally or alternatively, the third signaling includes a PCO IE, the PCO IE including a container indicating the list of identities. Additionally or alternatively, the apparatus is a MME. Additionally or alternatively, the network entity is a SM+PGW-C. Additionally or alternatively, the list of identities includes identities of one or more mobility management entities capable of processing the ePCO IEs.

In some implementations of the method and apparatuses described herein, a SMF+PGW-C receives, from a first network entity, a first signaling as a create session request message, the create session request message associated with an attach request from a UE; obtains a list of identities of network entities capable of processing extended policy configuration options (ePCO) IEs; and transmits, to the UE, a second signaling including an indication of the list of identities.

Some implementations of the method and apparatuses described herein may further include the attach request includes an ePCO IE, the ePCO IE including a message, the message including one or more IEs for triggering a policy association. Additionally or alternatively, the second signaling includes the indication of the list of identities based on the first network entity being incapable of processing ePCO IEs. Additionally or alternatively, the second signaling is transmitted to the UE via the first network entity. Additionally or alternatively, the create session request message includes a PCO IE, the PCO IE including a container having an identity, the identity indicating that the UE is capable of receiving URSP in an EPS. Additionally or alternatively, the attach request includes the PCO IE and an ePCO IE, and the create session request message excludes the ePCO IE. Additionally or alternatively, the second signaling includes a PCO IE, the PCO IE including a container indicating the list of identities. Additionally or alternatively, the procedure is a tracking area update procedure. Additionally or alternatively, the first network entity is a MME. Additionally or alternatively, the apparatus obtains the list of identities from a local configuration. Additionally or alternatively, the apparatus obtains the list of identities from a second network entity. Additionally or alternatively, the second network entity is a network repository function (NRF). Additionally or alternatively, the list of identities includes identities of one or more mobility management entities capable of processing the ePCO IEs.

### BRIEF DESCRIPTION OF THE DRAWINGS

FIG. 1 illustrates an example of a wireless communications system that supports enhanced methods for establishing UE policy association in accordance with aspects of the present disclosure.

FIG. 2 illustrates an example of a network architecture with the capability to transmit policy sections to a UE, as related to enhanced methods for establishing UE policy association in accordance with aspects of the present disclosure.

FIG. 3 illustrates an example flow diagram of a procedure for establish UE policy association, which supports enhanced methods for establishing UE policy association in accordance with aspects of the present disclosure.

FIGS. 4-6 illustrate an example of a block diagram of devices that supports enhanced methods for establishing UE policy association in accordance with aspects of the present disclosure.

FIGS. 7-10 illustrate flowcharts of methods that support enhanced methods for establishing UE policy association in accordance with aspects of the present disclosure.

### DETAILED DESCRIPTION

A wireless communications system includes a capability of triggering UE policy association establishment by a session management policy control function (SM-PCF) entity.

However, the existing methods rely on an assumption that the UE and intermediate network entities support processing ePCO IEs. Although this assumption may be valid for a UE and a SMF+PGW-C, it may not necessarily be valid for intermediate network entities (through which an ePCO IE is routed), such as a MME and/or SGW. As such, in some scenarios, the SMF+PGW-C may not receive the necessary message for triggering the UE policy association (because the MME or SGW is unable to process or forward the ePCO IE from the UE to the SMF+PGW-C). In other words, if ePCO is not supported by the MME or SGW, a UE that supports URSP in an EPS network may still be unable to trigger UE policy association and thereby receive UE policy sections from the PCF.

In aspects of enhanced methods for establishing UE policy association, this disclosure describes details for a UE to trigger UE policy association when an intervening MME or SGW is not capable of processing an ePCO IE. In an example, the UE sends an attach request to the MME that includes a PCO IE with a container identifier (ID) indicating that the UE supports URSP in the EPS (as well as an ePCO IE for triggering the UE policy association). If the SMF+PGW-C does not receive the ePCO IE (e.g., comprising a ‘UE STATE INDICATION’ message for triggering the UE policy association) from the MME, because the MME does not support processing the ePCO IE for example, then SMF+PGW-C sends to the UE identifiers of one or more other MMEs which support the ePCO IE in the registering public land mobile network (PLMN). In an example, SMF+PGW-C gets this information from another network entity such as a network repository function (NRF), or from a local configuration of the SMF+PGW-C. In an example, the UE then uses that information during a tracking area update procedure as a new RRC parameter to indicate to the base station which MME should be selected. For example, the tracking area update procedure can attempt to re-attach the UE to another MME that is capable of processing ePCO IEs.

In further aspects of enhanced methods for establishing UE policy association, an example SMF+PGW-C is configured to receive, during an attach procedure of a UE, extended PCO support indication (EPCOSI) bit value of ‘0’ or does not receive an ePCO IE comprising a ‘UE STATE INDICATION’ message from the UE, but receives a PCO IE with a new container ID indicating that the UE supports URSP in EPS. At this stage, the SMF+PGW-C may not be able to pass any policy information or request a SM-PCF for establishing the UE policy association for the UE. In this example, the SMF+PGW-C obtains information about other MMEs supporting the ePCO IE in the PLMN that the UE is registered to (e.g., from a local configuration and/or from a NRF). The SMF+PGW-C then transmits the information to the UE via the PCO IE with the new container ID. Further, in this example, the UE is configured to perform a tracking area update procedure to change its current serving MME (with or without changing SGW) by adding a parameter (e.g., in an RRC message from the UE to the serving base station) with candidate MME identities capable of processing the ePCO IE. In turn, the ePCO IE can be forwarded to the SMF+PGW-C so as to trigger the UE policy association and send back relevant policy information to the UE.

In further aspects of enhanced methods for establishing UE policy association, an example SMF+PGW-C receives: an EPCOSI with value ‘0’ indicating that an ePCO IE is not supported by network entities such as MME and/or SGW; and a container ID within a PCO IE indicating that a UE that send the PCO IE supports URSP rules transmission over EPS. In this example, SMF+PGW-C is configured to direct the UE to one or more different network entities, such as one or more MMEs and/or SGWs, which support processing an ePCO IE. In this example, the UE then communicates with a base station (e.g., eNB) about one or more candidate network entities (e.g., MME and/or SGW) supporting the ePCO IE, and proceeds with tracking area update (TAU) procedure to change its currently assigned MME and/or SGW to one or more of the candidate MME and/or SGW that supports processing the ePCO IE. In an example, the SMF+PGW-C then passes a UE STATE INDICATION message (obtained from the ePCO IE) to a SM-PCF. In an example, the SM-PCF determines that the UE has a capability for URSP transmission over EPS (e.g., based on information in a PCO IE from the UE, etc.). In an example, the SM-PCF then establishes UE policy association with the UE-PCF using the information received in the UE STATE INDICATION message. For example, the UE-PCF obtains URSP rules for the UE locally and/or via communication with a network entity such as a unified data repository (UDR), and then transmits those rules for receipt by the UE.

Thus, by configuring the UE to add information indicating that it is capable of URSP (e.g., in a PCO IE), example systems and methods advantageously herein enable the UE to trigger UE policy association even if it is initially assigned to an MME that is incapable of processing and/or forwarding the type of information needed to trigger UE policy association (e.g., a ‘UE STATE INDICATION’ message) in an EPS network. This enables an example communication device to provide advanced connectivity features for implementing suitable UE policies (e.g., QoS policies, etc.), even if the UE is operating in a network that has some legacy components (e.g., MMEs, SGWs, etc.) that are incapable of processing such types of messages (e.g., as part of an ePCO IE).

Aspects of the present disclosure are described in the context of a wireless communications system. Aspects of the present disclosure are further illustrated and described with reference to device diagrams and flowcharts.

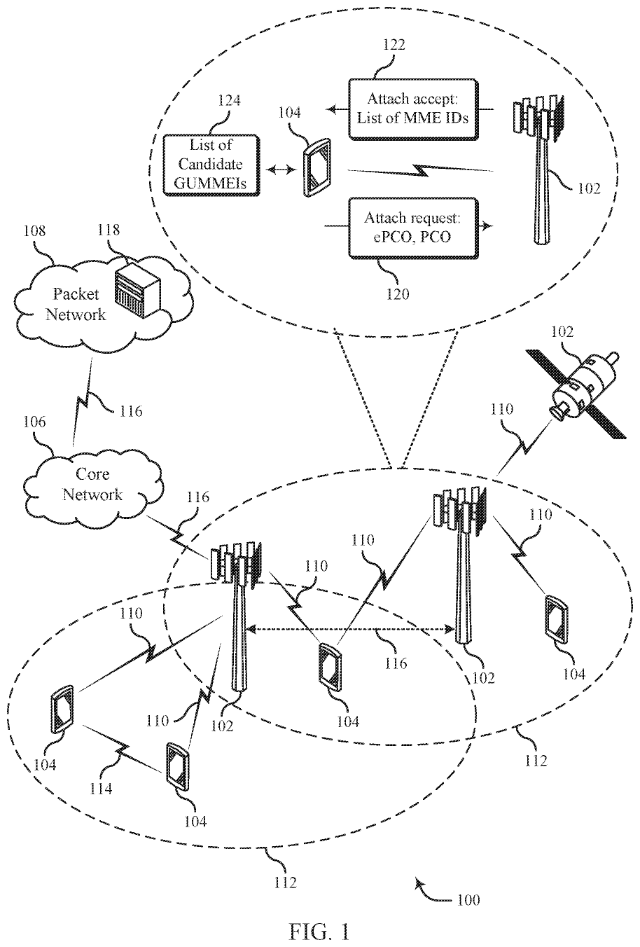

FIG. 1 illustrates an example of a wireless communications system 100 that supports enhanced methods for establishing UE policy association in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNB, a gNB, or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite (e.g., a non-terrestrial station (NTS)) associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IOT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1.

Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N6, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a MME, an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N6, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102.

The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100, such as time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., p=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHz-24.25 GHZ), FR4 (52.6 GHz-114.25 GHZ), FR4a or FR4-1 (52.6 GHz-71 GHZ), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the network entities 102 and the UEs 104 are operable to implement various aspects of enhanced methods for establishing UE policy association, as described herein. For instance, a UE 104 communicates an attach request 120 for receipt by an MME in the core network 106. In an example, the UE 104 may include, in the attach request 120, a message for triggering UE policy association (e.g., a UE STATE INDICATION message in an ePCO IE). In an example, the UE 104 may alternatively or additionally include, in the attach request 120 an indication that the UE 104 supports URSP in EPS (e.g., in a PCO IE). In at least one implementation, the MME that receives the attach request in the core network 106 is incapable of processing ePCO IEs, and thus ignores the ePCO IE and forwards the PCO IE indicating that the UE 104 supports URSP to the network (e.g., to a SM+PGW-C in the core network 106). In this implementation, the core network 106 (i.e., the SM+PGW-C) returns, to the UE via the MME and the base station 102 as the attach accept message 122, a list of identities of other MMEs in the core network 106 that are capable of processing the ePCO IE (i.e., the UE STATE INDICATION message). The UE 104 then performs the process 124 to determine a list of candidate generally unique MME identifiers (GUMMEIs). In some examples, the UE 104 may then send the list of GUMMEIs to the base station 102 (e.g., while performing a TAU procedure) to attempt re-attaching the UE 104 to a different MME that supports processing messages such as the ePCO IEs needed to trigger UE policy association.

With reference to policy management for access and mobility, policy control for session management and service data flow involves QoS control, gating control etc. In an example, a network can provide a UE with a URSP, which is a set of rules including traffic descriptors and route selection descriptors for the UE to establish a protocol data unit (PDU) session in a 5G system (5GS).

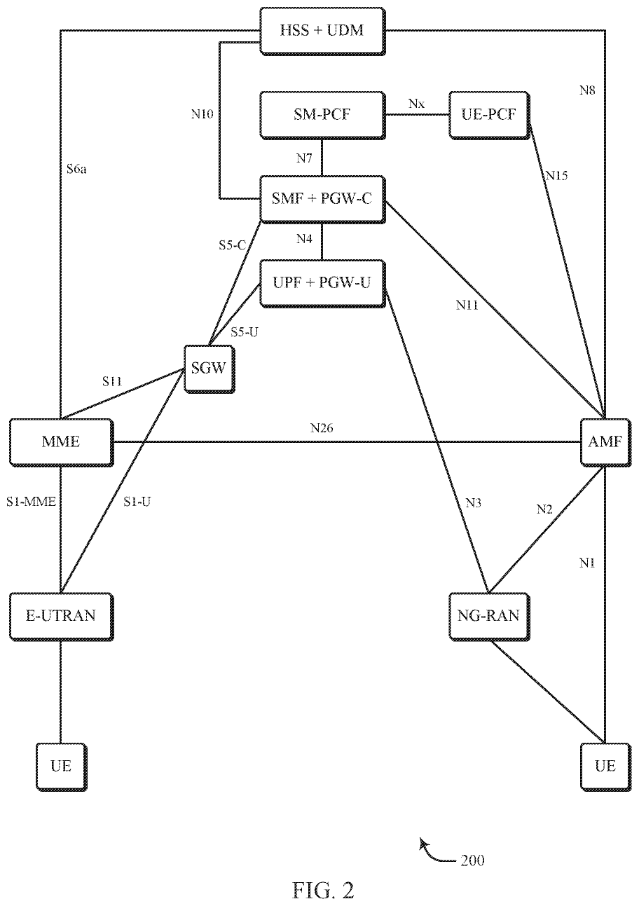

FIG. 2 illustrates an example of a network architecture 200 with the capability to transmit policy sections, as related to enhanced methods for establishing UE policy association. For example, the network architecture 200 may represent a non-roaming architecture for policy section delivery to a UE in EPS.

In an example, for the network to provide the URSP to the UE, the UE performs a UE-initiated UE state indication procedure at a time the UE register to the 5GS (e.g., at the time of initial registration or at the time of inter-system change from an S1 mode to N1 mode. To perform the UE-initiated UE state indication procedure, in an example, the UE provides a number of information elements to the PCF so that the PCF can arrange a number of URSP rules for the UE. The information elements that the UE provides in the UE STATE INDICATION message include, for example: a) a UE policy section identifier (UPSI) list information element which contains a number of UPSC assigned by a registered PLMN (RPLMN); b) A UE policy class mark information element comprising information about a policy aspect of the UE; and/or c) a UE operating system (OS) Ids information element indicating one or more OSs that the UE supports. In some examples, a length of the UE STATE INDICATION message is up to two octets or 65K octets.

In aspects of this disclosure, a UE-initiated UE state indication procedure for EPS is taken into consideration. In an example, enhanced UE policy (eUEPO) allows a UE to receive UE policy sections when the UE registers to an EPS network. Thus, the network architecture 200, in some examples, has the capability to transmit policy sections to the UE. In an example, the UE at the time of attachment to the EPS, requests establishment of a PDN connectivity and uses an ePCO to transmit a UE STATE INDICATION message to the SMF+PGW-C, which may later be forwarded to the SM-PCF as shown in the illustrated example to establish a UE policy association with the UE-PCF in order to provide the UE policy sections to the UE.

In some examples, ePCO comprises a container with a container ID (e.g., ‘0056H’) carrying a UE policy container with a length of two octets for two directions: a) from the UE to the PCF (where the UE STATE INDICATION message is included in the UE policy container); and b) from the network to the UE (where the UE policy section management list or any other information is carried from the PCF to the UE).

In an example, if the UE supports ePCO IEs, an ePCO is used by the UE to trigger the establishment of the UE policy association and thereby arrangement of the UE policy section management list or any other information that should be transmitted by the PCF to the UE. An example procedure for including the ePCO with the UE policy container IE in the attach procedure is involves the UE: a) including a new ePCO IE comprising a UE STATE INDICATION message within a PDN CONNECTIVITY REQUEST message; b) constructing an ATTACH REQUEST message comprising an evolved packet system session management (ESM) message containing an IE, the IE containing the PDN CONNECTIVITY REQUEST message; and c) setting a ePCO bit to a value that corresponds to “extended protocol configuration options supported” in a UE network capability IE of the ATTACH REQUEST message.

In examples, the UE then transmits the ATTACH REQUEST message towards the network. However, for this procedure to work, it is typically necessary that a network point of contact for this request (e.g., MME) supports processing the ePCO IE. However, in some applications such as early versions of the EPS when PCO IEs were introduced, some network entities such as MME or SGW may not necessarily support processing ePCO IEs. In some examples, if the MME is incapable of processing the ePCO IE from the UE, the MME may simply drop the ePCO comprising the UE STATE INDICATION message and therefore no UE policy association is established between the SM-PCF and the UE-PCF and as a result the UE will not receive any UE policy sections management list or any other information that it should receive from the PCF.

In aspects of enhanced methods for establishing UE policy association, UE policy association can be established without necessarily requiring UE interaction. In an example, to establish a UE policy association with the PCF, the NF service consumer (e.g., AMF) is configured to send an HTTP POST request with “{apiRoot}/npcf-ue-policy-control/v1/policies” as a resource uniform resource identifier (URI) and a PolicyAssociationRequest data structure as request body, which shall include: a) a Notification URI encoded as ‘notificationUri’ attribute; b) a subscription permanent identifier (SUPI) encoded as ‘supi’ attribute; and/or c) features supported by a NF service consumer encoded as ‘suppFeat’ attribute. In some examples, the request body also includes (e.g., when available): a received UE policy delivery protocol message encoded as ‘uePolReq’attribute.

In examples, UE policy delivery protocol message can be a ‘UE STATE INDICATION’ message. Therefore, in some examples, the UE STATE INDICATION message is not necessarily required to establish a UE policy association. Even if a UE STATE INDICATION message is not available a network entity service consumer (e.g., SM-PCF for EPS) can send an HTTP POST request without including a UE STATE INDICATION message to establish a UE policy association.

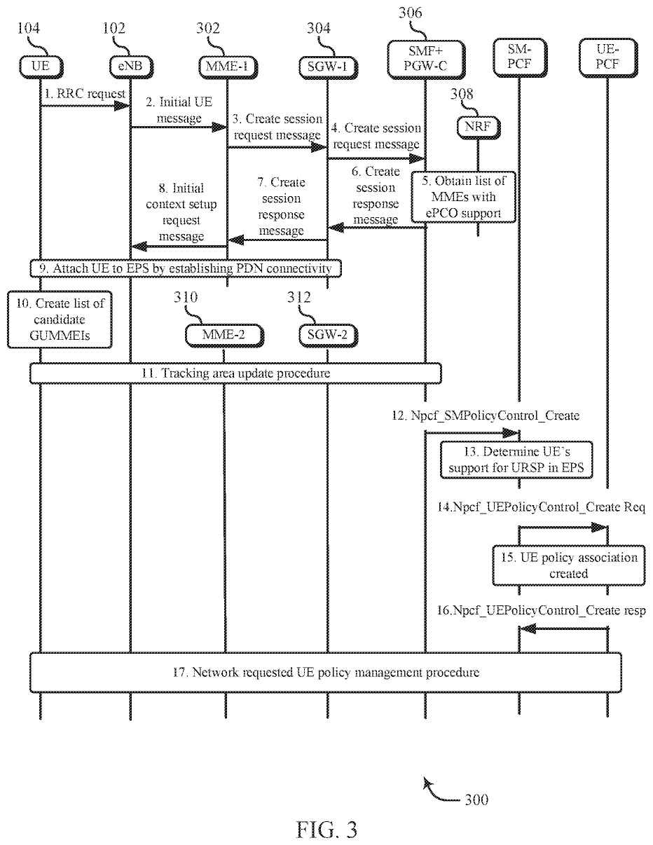

FIG. 3 illustrates an example of flow diagram of a procedure 300 for establishing UE policy association that supports enhanced methods for establishing UE policy association in accordance with aspects of the present disclosure. For example, the procedure 300 enables a UE that supports URSP in EPS to trigger UE policy association even if it sends an initial attach request (including the UE STATE INDICATION message) via one or more network entities (e.g., MME 302, SGW 304, etc.) that do not support processing the UE STATE INDICATION message (e.g., where the UE STATE INDICATION message is in an ePCO IE).

In the illustrated example, the UE 104 first sends a RRC request to the base station 102. The RRC request may include an attach request to register the UE 104 in the EPS network. To that end, in an example, the attach request may include an ePCO IE that includes the UE STATE INDICATION message; and a PCO IE that includes an indication that the UE 104 supports URSP in the EPS. For example, the UE initiates an initial attach procedure for PDN connectivity and performs the UE-initiated UE state indication procedure by including a UE STATE INDICATION message comprising: a) the UPSI list; b) a UE policy class mark including the UE's support for access network discovery and selection policy (ANDSP); and/or c) (optionally) OS Ids supported by the UE 104. In an example, the UE 104 sends the UE STATE INDICATION message in an ePCO IE comprising a container (e.g., with container ID 0056H) to carry the UE policy container. In an example, the UE 104 also includes an identity of any PDU session which is to be transferred from the 5GS to UE Policy selection (UPS) in the ePCO.

In some examples, since it is may not be yet clear if the network supports processing the ePCO IE, the UE 104 may also include a PCO IE with a certain container ID to indicate that the UE is capable for URSP in the EPS. In an example, the UE 104 includes both the ePCO IE comprising the UE STATE INDICATION message and the PCO IE, within a PDN CONNECTIVITY REQUEST message. In an example, the UE constructs an ATTACH REQUEST message comprising an ESM message containing an IE, the IE containing the PDN CONNECTIVITY REQUEST message. In an example, the UE also sets an ePCO bit to correspond to “extended protocol configuration options supported” in a UE network capability IE of the ATTACH REQUEST message. In an example, the UE transmits the ATTACH REQUEST message towards the network (e.g., via base station 102, MME 302, SGW 304 for receipt at SMF+PGW-C 306).

Next, in the illustrated example, the base station 102 sends an initial UE message (containing the attach request) to the MME 302.

Next, in the illustrated example, the MME 302 then selects an SGW 304 for uplink traffic on S1_U reference point and exchanges create session request and create session response messages. In an example, the MME 302 selects SGW 304 based on network topology, i.e. the selected SGW 304 serves the location of UE 104 and/or overlapping SGW 304 service areas. For example, the selection may prefer SGWs with service areas that reduce a probability of changing the serving SGW. For the sake of example, is assumed that the MME 302 does not support ePCO, therefore when constructing the create session request message, MME 302 does not include the ePCO comprising the UE STATE INDICATION message received from the base station 102.

Consequently, for example, the MME 302 does not set an ePCO support indication on the S11 interface (shown in FIG. 2) to inform the SGW 304. However, the PCO with the container ID indicating that the UE supports the URSP in the EPS is included in the create session request message sent from the MME 302 to the SGW 304. In the illustrated example, the MME 302 transmits transmits the create session request message to the SGW 304.

Next, in the illustrated example, SGW 304 creates a new entry in its EPS bearer context table and sends create session request message comprising the PCO IE with the container ID indicating that the UE 104 supports the URSP in the EPS, an access point name (APN), a serving gateway (GW) address, a PDN address, a subscribed APN, and PCO towards the SMF+PGW-C 306 indicated by the SMF+PGW-C address received from the MME 302 in the previous step.

Next, in the illustrated example, the SMF+PGW-C 306 obtains a list of MMEs with ePCO support (e.g., from a local configuration and/or from the NRF 308). For example, upon receipt of the create session request message from SGW 304, the SMF+PGW-C determines, based on a) lack of ePCO IE support since an EPCOSI bit of an Indication information element is not set to a value ‘1’ and b) a PCO IE with a container ID indicating that the UE 104 supports the URSP in the EPS is received, that the MME 302 and/or SGW 304 does not support the ePCO IE and therefore, the transmitted ePCO IE comprising the UE STATE INICATION message has been omitted during transmission of the attach request from the UE 104 to the SMF+PGW-C 306. In an example, the SMF+PGW-C 306 responsively obtains MME identities and/or SGW identities which are capable of ePCO handling (e.g., from the NRF 308 and/or from a local configuration of the SMF+PGW-C 306).

Next, in the illustrated example, the SMF+PGW-C constructs a create session response message comprising the PCO IE with the container ID indicating that the UE supports the URSP, as well as a list of MME identifiers and/or SGW identifiers of MMEs and/or SGWs capable of handling ePCO IEs. The SMF+PGW-C forwards the create session response message towards the SGW 304.

Next, in the illustrated example, the SGW 304 forwards the create session response message towards the MME 302.

Next, in the illustrated example, the MME 302 sends an initial context setup request message (e.g., including an attach accept message with the PCO IE that includes the list of MME IDs). For example, upon receipt of the create session response message from SGW 304, the MME 302 creates the ATTACH ACCEPT message comprising the ESM message containing an IE, the IE containing an ACTIVATE DEFAULT EPS BEARER CONTEXT REQUEST message, where the ACTIVATE DEFAULT EPS BEARER CONTEXT REQUEST message includes the PCO IE with the container ID comprising the list of MME identities and/or SGW identities. In an example, the MME 302 transmits the ATTACH ACCEPT message towards the UE 104 (e.g., via the base station 102) in the initial context setup request message and receives the initial context setup response message from the UE 104.

Next, in the illustrated example, the UE 104 completes the attach procedure to attach to the EPS by establishing PDN connectivity.

Next, in the illustrated example, the UE 104 uses the MME identities it has received in the PCO from the SMF+PGW-C and its PLMN identity (e.g., mobile country code (MCC) +mobile network code (MNC)) to create a new parameter which is a ‘list of candidate GUMMEIs’ capable of processing ePCO IEs. In an example, a GUMMEI is defined as <GUMMEI>=<MCC><MNC><MME Identifier>.

Next, in the illustrated example, the UE 104 is configured to perform a procedure (e.g., TAU) using the parameter indicating the GUMMEIs. For example, the UE 104 includes the parameter that indicates the ‘list of candidate GUMMEIs’ described in the previous step in a RRC message to the base station 102. In an example, the UE attempts to perform the TAU procedure with or without SGW (depending on whether an SGW support the ePCO IE is available or not). In this TAU procedure the UE, for example, sends a RRC message to the base station 102 that: a) includes the ePCO IE comprising the UE STATE INDICATION message; and b) optionally includes the PCO IE with the new container ID indication the UE capability for the URSP in the EPS. In an example, the UE 104 also includes a new parameter ‘list of candidate GUMMEIs’ in the RRC message (e.g., RRC message 5 RRCConnectionSetupComplete message) to indicate to the base station 102 to allocate an MME with a MME identifier listed in the new parameter ‘list of candidate GUMMEIs.’ For example, this attach attempt may be via MME 310 which is capable of processing ePCO IEs. In an example, MME 310 locates SGW 312 which is also capable of handling the ePCO IE. Therefore, in an example, MME 310 and SGW 312 set a EPCOSI bit of the Indication information element to a value ‘1’ when passing the create session request message towards the SMF+PGW-C 306.

Next, in the illustrated example, upon receipt of the create session request message and determining that it includes the ePCO IE comprising the UE STATE INDICATION message from the UE 104, the SMF+PGW-C determines that the UE 104 supports the URSP in the EPS and responsively forwards the UE STATE INDICATION message towards the SM-PCF using an HTTP POST request.

Next, in the illustrated example, the SM-PCF based on the information provided by the SMF+PGW-C determines that the UE 104 supports UE policy sections management list in the EPS. The SM-PCF may check the UE's support for the UE policy section management list including receiving the URSP using UE context policy control subscription information in UDR as a basis to decide whether to establish a UE policy association towards the UE policy control function UE (UE-PCF).

Next, in the illustrated example (e.g., steps 14-16), the SM-PCF selects UE-PCF to establish the UE policy association in the EPS with the UE 104. The new UE policy association is requested by the SM-PCF by transmitting the UE STATE INDICATION message to the UE-PCF.

Finally, in the illustrated example, the UE policy association is established and the UE-PCF transmits the new policy section management including the URSP towards the UE by performing a network requested UE policy management procedure.

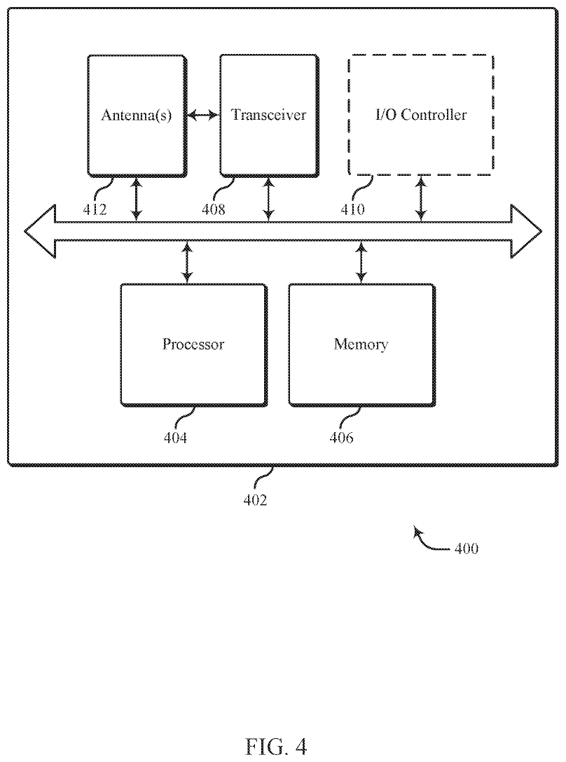

FIG. 4 illustrates an example of a block diagram 400 of a device 402 that supports enhanced methods for establishing UE policy association in accordance with aspects of the present disclosure. The device 402 may be an example of a UE 104 as described herein. The device 402 may support wireless communication with one or more network entities 102, UEs 104, or any combination thereof. The device 402 may include components for bi-directional communications including components for transmitting and receiving communications, such as a processor 404, a memory 406, a transceiver 408, and an I/O controller 410. These components may be in electronic communication or otherwise coupled (e.g., operatively, communicatively, functionally, electronically, electrically) via one or more interfaces (e.g., buses).

The processor 404, the memory 406, the transceiver 408, or various combinations thereof or various components thereof may be examples of means for performing various aspects of the present disclosure as described herein. For example, the processor 404, the memory 406, the transceiver 408, or various combinations or components thereof may support a method for performing one or more of the operations described herein.

In some implementations, the processor 404, the memory 406, the transceiver 408, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 404 and the memory 406 coupled with the processor 404 may be configured to perform one or more of the functions described herein (e.g., executing, by the processor 404, instructions stored in the memory 406).

For example, the processor 404 may support wireless communication at the device 402 in accordance with examples as disclosed herein. The processor 404 may be configured as or otherwise support a means for transmitting, from a UE to a first network entity, a first signaling indicating an attach request; receiving a second signaling in response to transmitting the first signaling, the second signaling including an indication of a list of identities of network entities capable of processing ePCO IEs; and performing a procedure by transmitting an ePCO IE to a second network entity via one or more of the network entities identified in the list of identities.

Additionally, the processor 404 may be configured as or otherwise support any one or combination of using a parameter in a RRC message to indicate at least one identity from the list of identities for performing the procedure. Additionally or alternatively, the second signaling includes the indication of the list of identities based on the first network entity being incapable of processing ePCO IEs. Additionally or alternatively, the second signaling is received from the second network entity via the first network entity. Additionally or alternatively, the ePCO IE includes a message, the message including one or more IEs for triggering a policy association.

Additionally or alternatively, the attach request includes a PCO IE, the PCO IE including a container having an identity, the identity indicating that the UE is capable of receiving URSP in an EPS network. Additionally or alternatively, the second signaling includes a PCO IE from the second network entity, the PCO IE including a container indicating the list of identities. Additionally or alternatively, the procedure is a tracking area update procedure. Additionally or alternatively, the first network entity is a MME. the second network entity is a SM+PGW-C. Additionally or alternatively, the list of identities includes identities of one or more mobility management entities capable of processing the ePCO IEs.

Additionally, or alternatively, the device 402, in accordance with examples as disclosed herein, may include a processor; and a memory coupled with the processor, the processor configured to cause the apparatus to: transmit, to a first network entity, a first signaling indicating an attach request; receive a second signaling in response to transmitting the first signaling, the second signaling including an indication of a list of identities of network entities capable of processing ePCO IEs; and perform a procedure by transmitting an ePCO IE to a second network entity via one or more of the network entities identified in the list of identities.

Additionally, the wireless communication at the device 402 may include any one or combination of the apparatus uses a parameter in a RRC message to indicate at least one identity from the list of identities for performing the procedure. Additionally or alternatively, the second signaling includes the indication of the list of identities based on the first network entity being incapable of processing ePCO IEs. Additionally or alternatively, the second signaling is received from the second network entity via the first network entity. Additionally or alternatively, the ePCO IE includes a message, the message including one or more IEs for triggering a policy association. Additionally or alternatively, the attach request includes a PCO IE, the PCO IE including a container having an identity, the identity indicating that the apparatus is capable of receiving URSP in an EPS network. Additionally or alternatively, the second signaling includes a PCO IE from the second network entity, the PCO IE including a container indicating the list of identities.

Additionally or alternatively, the procedure is a tracking area update procedure. Additionally or alternatively, the first network entity is a MME. Additionally or alternatively, the second network entity is a SM+PGW-C. Additionally or alternatively, the list of identities includes identities of one or more mobility management entities capable of processing the ePCO IEs.

The processor 404 of the device 402, such as a UE 104, may support wireless communication in accordance with examples as disclosed herein. The processor 404 includes at least one controller coupled with at least one memory, and the at least one controller is configured to and/or operable to cause the processor to transmit, to a first network entity, a first signaling indicating an attach request; receive a second signaling in response to transmitting the first signaling, the second signaling including an indication of a list of identities of network entities capable of processing extended protocol configuration options (ePCO) information elements (IEs); and perform a procedure by transmitting an ePCO information element (IE) to a second network entity via one or more of the network entities identified in the list of identities.

The processor 404 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 404 may be configured to operate a memory array using a memory controller. In some other implementations, a memory controller may be integrated into the processor 404. The processor 404 may be configured to execute computer-readable instructions stored in a memory (e.g., the memory 406) to cause the device 402 to perform various functions of the present disclosure.

The memory 406 may include random access memory (RAM) and read-only memory (ROM). The memory 406 may store computer-readable, computer-executable code including instructions that, when executed by the processor 404 cause the device 402 to perform various functions described herein. The code may be stored in a non-transitory computer-readable medium such as system memory or another type of memory. In some implementations, the code may not be directly executable by the processor 404 but may cause a computer (e.g., when compiled and executed) to perform functions described herein. In some implementations, the memory 406 may include, among other things, a basic I/O system (BIOS) which may control basic hardware or software operation such as the interaction with peripheral components or devices.

The I/O controller 410 may manage input and output signals for the device 402. The I/O controller 410 may also manage peripherals not integrated into the device M02. In some implementations, the I/O controller 410 may represent a physical connection or port to an external peripheral. In some implementations, the I/O controller 410 may utilize an operating system such as Ios®, ANDROID®, MS-DOS®, MS-WINDOWS®, OS/2®, UNIX®, LINUX®, or another known operating system. In some implementations, the I/O controller 410 may be implemented as part of a processor, such as the processor 404. In some implementations, a user may interact with the device 402 via the I/O controller 410 or via hardware components controlled by the I/O controller 410.

In some implementations, the device 402 may include a single antenna 412. However, in some other implementations, the device 402 may have more than one antenna 412 (i.e., multiple antennas), including multiple antenna panels or antenna arrays, which may be capable of concurrently transmitting or receiving multiple wireless transmissions. The transceiver 408 may communicate bi-directionally, via the one or more antennas 412, wired, or wireless links as described herein. For example, the transceiver 408 may represent a wireless transceiver and may communicate bi-directionally with another wireless transceiver. The transceiver 408 may also include a modem to modulate the packets, to provide the modulated packets to one or more antennas 412 for transmission, and to demodulate packets received from the one or more antennas 412.

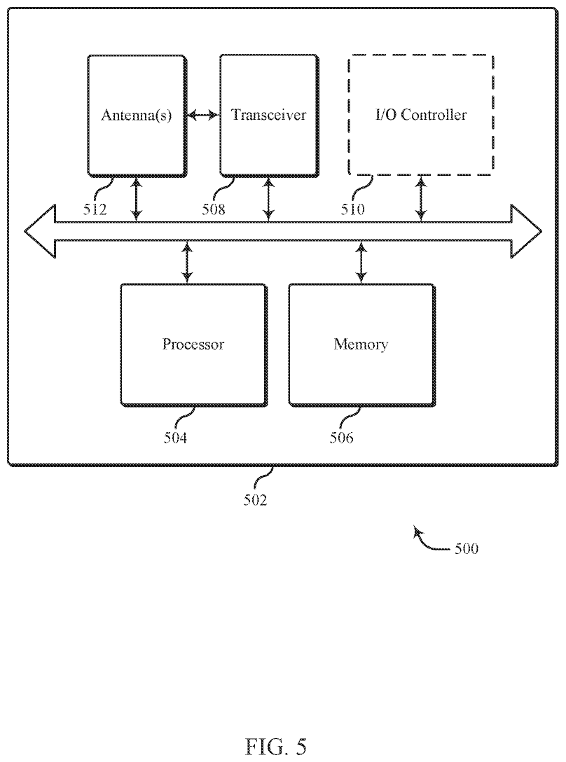

FIG. 5 illustrates an example of a block diagram 500 of a device 502 that supports enhanced methods for establishing UE policy association in accordance with aspects of the present disclosure. The device 502 may be an example of a network entity (e.g., MME 302) as described herein. The device 502 may support wireless communication with one or more network entities 102, Ues 104, or any combination thereof. The device 502 may include components for bi-directional communications including components for transmitting and receiving communications, such as a processor 504, a memory 506, a transceiver 508, and an I/O controller 510. These components may be in electronic communication or otherwise coupled (e.g., operatively, communicatively, functionally, electronically, electrically) via one or more interfaces (e.g., buses).

The processor 504, the memory 506, the transceiver 508, or various combinations thereof or various components thereof may be examples of means for performing various aspects of the present disclosure as described herein. For example, the processor 504, the memory 506, the transceiver 508, or various combinations or components thereof may support a method for performing one or more of the operations described herein.

In some implementations, the processor 504, the memory 506, the transceiver 508, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 504 and the memory 506 coupled with the processor 504 may be configured to perform one or more of the functions described herein (e.g., executing, by the processor 504, instructions stored in the memory 506).

For example, the processor 504 may support wireless communication at the device 502 in accordance with examples as disclosed herein. The processor 504 may be configured as or otherwise support a means for receiving, at a first network entity from a UE, a first signaling indicating an attach request; transmitting, to a second network entity, a second signaling as a create session request message based on the attach request; receiving, from the second network entity, a third signaling that includes an indication of a list of identities of network entities capable of processing extended policy configuration options (Epco) les; and transmitting, for receipt at the UE, a fourth signaling indicating the list of identities.

Additionally, the processor 504 may be configured as or otherwise support any one or combination of the third signaling includes the indication of the list of identities based on the apparatus being incapable of processing Epco Ies. Additionally or alternatively, the attach request includes an Epco IE, the Epco IE including a message, the message including one or more Ies for triggering a policy association. Additionally or alternatively, the attach request includes a PCO IE, the PCO IE including a container having an identity, the identity indicating that the UE is capable of receiving URSP in an EPS. Additionally or alternatively, the create session request message includes the PCO IE and excludes the Epco IE. Additionally or alternatively, the third signaling includes a PCO IE, the PCO IE including a container indicating the list of identities. Additionally or alternatively, the first network entity is a MME. Additionally or alternatively, the second network entity is a SM+PGW-C. Additionally or alternatively, the list of identities includes identities of one or more mobility management entities capable of processing the Epco Ies.

Additionally, or alternatively, the device 502, in accordance with examples as disclosed herein, may include a processor; and a memory coupled with the processor, the processor configured to cause the apparatus to: receive, from a UE, a first signaling indicating an attach request; transmit, to a network entity, a second signaling as a create session request message based on the attach request; and receive, from the network entity, a third signaling that includes an indication of a list of identities of network entities capable of processing extended policy configuration options (Epco) les; and transmit, for receipt at the UE, a fourth signaling indicating the list of identities.

Additionally, the wireless communication at the device 502 may include any one or combination of the third signaling includes the indication of the list of identities based on the apparatus being incapable of processing Epco Ies. Additionally or alternatively, the attach request includes an Epco IE, the Epco IE including a message, the message including one or more Ies for triggering a policy association. Additionally or alternatively, the attach request includes a PCO IE, the PCO IE including a container having an identity, the identity indicating that the UE is capable of receiving URSP in an EPS. Additionally or alternatively, the create session request message includes the PCO IE and excludes the Epco IE. Additionally or alternatively, the third signaling includes a PCO IE, the PCO IE including a container indicating the list of identities. Additionally or alternatively, the apparatus is a MME. Additionally or alternatively, the network entity is a SM+PGW-C. Additionally or alternatively, the list of identities includes identities of one or more mobility management entities capable of processing the Epco Ies.

The processor 504 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 504 may be configured to operate a memory array using a memory controller. In some other implementations, a memory controller may be integrated into the processor 504. The processor 504 may be configured to execute computer-readable instructions stored in a memory (e.g., the memory 506) to cause the device 502 to perform various functions of the present disclosure.

The memory 506 may include random access memory (RAM) and read-only memory (ROM). The memory 506 may store computer-readable, computer-executable code including instructions that, when executed by the processor 504 cause the device 502 to perform various functions described herein. The code may be stored in a non-transitory computer-readable medium such as system memory or another type of memory. In some implementations, the code may not be directly executable by the processor 504 but may cause a computer (e.g., when compiled and executed) to perform functions described herein. In some implementations, the memory 506 may include, among other things, a basic I/O system (BIOS) which may control basic hardware or software operation such as the interaction with peripheral components or devices.

The I/O controller 510 may manage input and output signals for the device 502. The I/O controller 510 may also manage peripherals not integrated into the device 502. In some implementations, the I/O controller 510 may represent a physical connection or port to an external peripheral. In some implementations, the I/O controller 510 may utilize an operating system such as Ios®, ANDROID®, MS-DOS®, MS-WINDOWS®, OS/2®, UNIX®, LINUX®, or another known operating system. In some implementations, the I/O controller 510 may be implemented as part of a processor, such as the processor 504. In some implementations, a user may interact with the device 502 via the I/O controller 510 or via hardware components controlled by the I/O controller 510.

In some implementations, the device 502 may include a single antenna 512. However, in some other implementations, the device 502 may have more than one antenna 512 (i.e., multiple antennas), including multiple antenna panels or antenna arrays, which may be capable of concurrently transmitting or receiving multiple wireless transmissions. The transceiver 508 may communicate bi-directionally, via the one or more antennas 512, wired, or wireless links as described herein. For example, the transceiver 508 may represent a wireless transceiver and may communicate bi-directionally with another wireless transceiver. The transceiver 508 may also include a modem to modulate the packets, to provide the modulated packets to one or more antennas 512 for transmission, and to demodulate packets received from the one or more antennas 512.

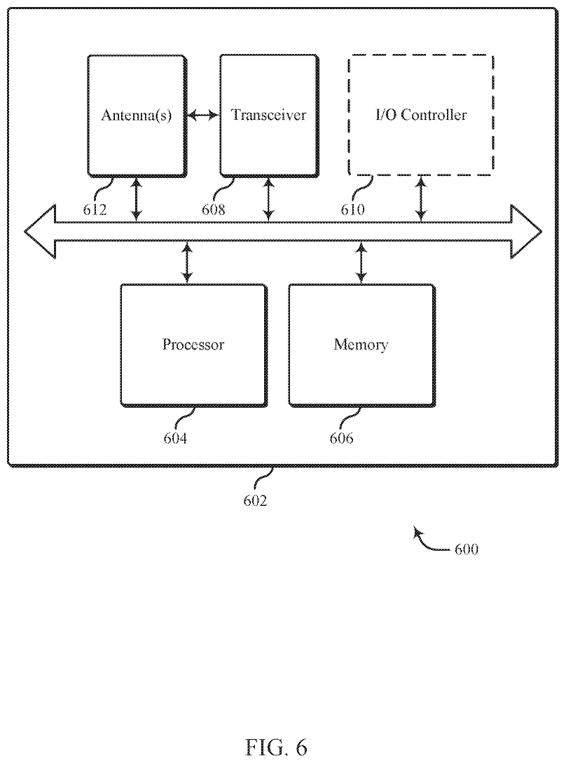

FIG. 6 illustrates an example of a block diagram 600 of a device 602 that supports enhanced methods for establishing UE policy association in accordance with aspects of the present disclosure. The device 602 may be an example of a network entity (e.g., SMF+PGW-C 306) as described herein. The device 602 may support wireless communication with one or more network entities 102, Ues 104, or any combination thereof. The device 602 may include components for bi-directional communications including components for transmitting and receiving communications, such as a processor 604, a memory 606, a transceiver 608, and an I/O controller 610. These components may be in electronic communication or otherwise coupled (e.g., operatively, communicatively, functionally, electronically, electrically) via one or more interfaces (e.g., buses).

The processor 604, the memory 606, the transceiver 608, or various combinations thereof or various components thereof may be examples of means for performing various aspects of the present disclosure as described herein. For example, the processor 604, the memory 606, the transceiver 608, or various combinations or components thereof may support a method for performing one or more of the operations described herein.

In some implementations, the processor 604, the memory 606, the transceiver 608, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 604 and the memory 606 coupled with the processor 604 may be configured to perform one or more of the functions described herein (e.g., executing, by the processor 604, instructions stored in the memory 606).

For example, the processor 604 may support wireless communication at the device 602 in accordance with examples as disclosed herein. The processor 604 may be configured as or otherwise support a means for receiving, from a first network entity, a first signaling as a create session request message, the create session request message associated with an attach request from a UE; obtaining a list of identities of network entities capable of processing extended policy configuration options (Epco) Ies; and transmitting, to the UE, a second signaling including an indication of the list of identities.

Additionally, the processor 604 may be configured as or otherwise support any one or combination of the attach request includes an Epco IE, the Epco IE including a message, the message including one or more Ies for triggering a policy association. Additionally or alternatively, the second signaling includes the indication of the list of identities based on the first network entity being incapable of processing Epco Ies. Additionally or alternatively, the second signaling is transmitted to the UE via the first network entity. Additionally or alternatively, the create session request message includes a PCO IE, the PCO IE including a container having an identity, the identity indicating that the UE is capable of receiving URSP in an EPS. Additionally or alternatively, the attach request includes the PCO IE and an Epco IE, and the create session request message excludes the Epco IE. Additionally or alternatively, the second signaling includes a PCO IE, the PCO IE including a container indicating the list of identities. Additionally or alternatively, the procedure is a trACKIng area update procedure. Additionally or alternatively, the first network entity is a MME. Additionally or alternatively, obtaining the list of identities is from a local configuration. Additionally or alternatively, obtaining the list of identities is from a second network entity. Additionally or alternatively, the second network entity is a network repository function (NRF). Additionally or alternatively, the list of identities includes identities of one or more mobility management entities capable of processing the Epco Ies.

Additionally, or alternatively, the device 602, in accordance with examples as disclosed herein, may include a processor; and a memory coupled with the processor, the processor configured to cause the apparatus to: receive, from a first network entity, a first signaling as a create session request message, the create session request message associated with an attach request from a UE; obtain a list of identities of network entities capable of processing extended policy configuration options (Epco) Ies; and transmit, to the UE, a second signaling including an indication of the list of identities.

Additionally, the wireless communication at the device 602 may include any one or combination of the attach request includes an Epco IE, the Epco IE including a message, the message including one or more Ies for triggering a policy association. Additionally or alternatively, the second signaling includes the indication of the list of identities based on the first network entity being incapable of processing Epco Ies. Additionally or alternatively, the second signaling is transmitted to the UE via the first network entity. Additionally or alternatively, the create session request message includes a PCO IE, the PCO IE including a container having an identity, the identity indicating that the UE is capable of receiving URSP in an EPS. Additionally or alternatively, the attach request includes the PCO IE and an Epco IE, and the create session request message excludes the Epco IE. Additionally or alternatively, the second signaling includes a PCO IE, the PCO IE including a container indicating the list of identities. Additionally or alternatively, the procedure is a trACKIng area update procedure. Additionally or alternatively, the first network entity is a MME. Additionally or alternatively, the apparatus obtains the list of identities from a local configuration. Additionally or alternatively, the apparatus obtains the list of identities from a second network entity. Additionally or alternatively, the second network entity is a network repository function (NRF). Additionally or alternatively, the list of identities includes identities of one or more mobility management entities capable of processing the Epco Ies.

The processor 604 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 604 may be configured to operate a memory array using a memory controller. In some other implementations, a memory controller may be integrated into the processor 604. The processor 604 may be configured to execute computer-readable instructions stored in a memory (e.g., the memory 606) to cause the device 602 to perform various functions of the present disclosure.

The memory 606 may include random access memory (RAM) and read-only memory (ROM). The memory 606 may store computer-readable, computer-executable code including instructions that, when executed by the processor 604 cause the device 602 to perform various functions described herein. The code may be stored in a non-transitory computer-readable medium such as system memory or another type of memory. In some implementations, the code may not be directly executable by the processor 604 but may cause a computer (e.g., when compiled and executed) to perform functions described herein. In some implementations, the memory 606 may include, among other things, a basic I/O system (BIOS) which may control basic hardware or software operation such as the interaction with peripheral components or devices.

The I/O controller 610 may manage input and output signals for the device 602. The I/O controller 610 may also manage peripherals not integrated into the device M02. In some implementations, the I/O controller 610 may represent a physical connection or port to an external peripheral. In some implementations, the I/O controller 610 may utilize an operating system such as Ios®, ANDROID®, MS-DOS®, MS-WINDOWS®, OS/2®, UNIX®, LINUX®, or another known operating system. In some implementations, the I/O controller 610 may be implemented as part of a processor, such as the processor 604. In some implementations, a user may interact with the device 602 via the I/O controller 610 or via hardware components controlled by the I/O controller 610.

In some implementations, the device 602 may include a single antenna 612. However, in some other implementations, the device 602 may have more than one antenna 612 (i.e., multiple antennas), including multiple antenna panels or antenna arrays, which may be capable of concurrently transmitting or receiving multiple wireless transmissions. The transceiver 608 may communicate bi-directionally, via the one or more antennas 612, wired, or wireless links as described herein. For example, the transceiver 608 may represent a wireless transceiver and may communicate bi-directionally with another wireless transceiver. The transceiver 608 may also include a modem to modulate the packets, to provide the modulated packets to one or more antennas 612 for transmission, and to demodulate packets received from the one or more antennas 612.

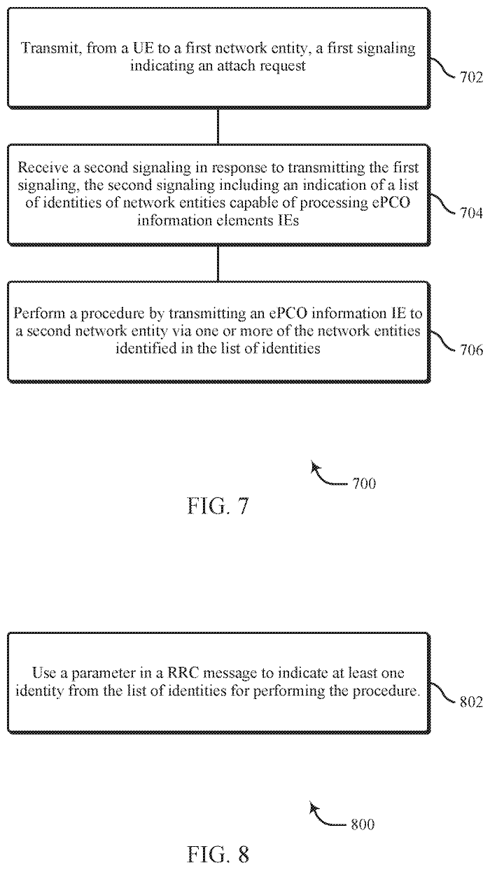

FIG. 7 illustrates a flowchart of a method 700 that supports enhanced methods for establishing UE policy association in accordance with aspects of the present disclosure. The operations of the method 700 may be implemented by a device or its components as described herein. For example, the operations of the method 700 may be performed by a UE 104 as described with reference to FIGS. 1 through 6. In some implementations, the device may execute a set of instructions to control the function elements of the device to perform the described functions.

Additionally, or alternatively, the device may perform aspects of the described functions using special-purpose hardware.

At 702, the method may include transmitting, from a UE to a first network entity, a first signaling indicating an attach request. The operations of 702 may be performed in accordance with examples as described herein. In some implementations, aspects of the operations of 702 may be performed by a device as described with reference to FIG. 1.

At 704, the method may include receiving a second signaling in response to transmitting the first signaling, the second signaling including an indication of a list of identities of network entities capable of processing Epco Ies. The operations of 704 may be performed in accordance with examples as described herein. In some implementations, aspects of the operations of 704 may be performed by a device as described with reference to FIG. 1.

At 706, the method may include performing a procedure by transmitting an Epco IE to a second network entity via one or more of the network entities identified in the list of identities. The operations of 706 may be performed in accordance with examples as described herein. In some implementations, aspects of the operations of 706 may be performed by a device as described with reference to FIG. 1.

FIG. 8 illustrates a flowchart of a method 800 that supports enhanced methods for establishing UE policy association in accordance with aspects of the present disclosure. The operations of the method 800 may be implemented by a device or its components as described herein. For example, the operations of the method 800 may be performed by a UE 104 as described with reference to FIGS. 1 through 6. In some implementations, the device may execute a set of instructions to control the function elements of the device to perform the described functions.

Additionally, or alternatively, the device may perform aspects of the described functions using special-purpose hardware.

At 802, the method may include using a parameter in a RRC message to indicate at least one identity from the list of identities for performing the procedure. The operations of 802 may be performed in accordance with examples as described herein. In some implementations, aspects of the operations of 802 may be performed by a device as described with reference to FIG. 1.

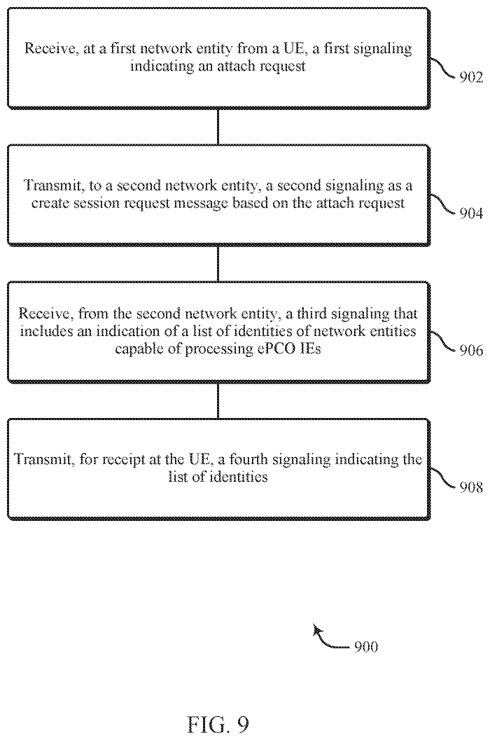

FIG. 9 illustrates a flowchart of a method 900 that supports enhanced methods for establishing UE policy association in accordance with aspects of the present disclosure. The operations of the method 900 may be implemented by a device or its components as described herein. For example, the operations of the method 900 may be performed by a network entity (e.g., MME 302) as described with reference to FIGS. 1 through 6. In some implementations, the device may execute a set of instructions to control the function elements of the device to perform the described functions. Additionally, or alternatively, the device may perform aspects of the described functions using special-purpose hardware.

At 902, the method may include receiving, at a first network entity from a UE, a first signaling indicating an attach request. The operations of 902 may be performed in accordance with examples as described herein. In some implementations, aspects of the operations of 902 may be performed by a device as described with reference to FIG. 1.

At 904, the method may include transmitting, to a second network entity, a second signaling as a create session request message based on the attach request. The operations of 904 may be performed in accordance with examples as described herein. In some implementations, aspects of the operations of 904 may be performed by a device as described with reference to FIG. 1.

At 906, the method may include receiving, from the second network entity, a third signaling that includes an indication of a list of identities of network entities capable of processing extended policy configuration options (Epco) Ies. The operations of 906 may be performed in accordance with examples as described herein. In some implementations, aspects of the operations of 906 may be performed by a device as described with reference to FIG. 1.

At 908, the method may include transmitting, for receipt at the UE, a fourth signaling indicating the list of identities. The operations of 908 may be performed in accordance with examples as described herein. In some implementations, aspects of the operations of 906 may be performed by a device as described with reference to FIG. 1.

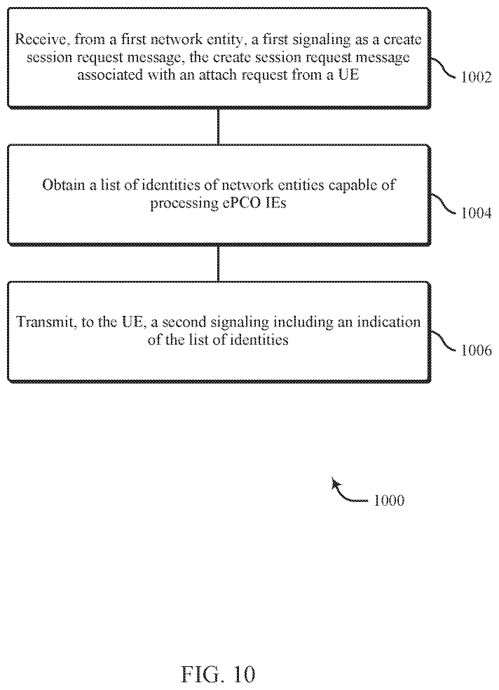

FIG. 10 illustrates a flowchart of a method 1000 that supports enhanced methods for establishing UE policy association in accordance with aspects of the present disclosure. The operations of the method 1000 may be implemented by a device or its components as described herein. For example, the operations of the method 1000 may be performed by a network entity (e.g., SM+PGW-C 306) as described with reference to FIGS. 1 through 6. In some implementations, the device may execute a set of instructions to control the function elements of the device to perform the described functions. Additionally, or alternatively, the device may perform aspects of the described functions using special-purpose hardware.

At 1002, the method may include receiving, from a first network entity, a first signaling as a create session request message, the create session request message associated with an attach request from a UE. The operations of 1002 may be performed in accordance with examples as described herein. In some implementations, aspects of the operations of 1002 may be performed by a device as described with reference to FIG. 1.

At 1004, the method may include obtaining a list of identities of network entities capable of processing extended policy configuration options (Epco) Ies. The operations of 1004 may be performed in accordance with examples as described herein. In some implementations, aspects of the operations of 1004 may be performed by a device as described with reference to FIG. 1.

At 1006, the method may include transmitting, to the UE, a second signaling including an indication of the list of identities. The operations of 1006 may be performed in accordance with examples as described herein. In some implementations, aspects of the operations of 1006 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Similarly, a list of one or more of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”.

Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
transmit, to a first network entity, a first signaling indicating an attach request;
receive a second signaling in response to transmitting the first signaling, the second signaling including an indication of a list of identities of network entities capable of processing extended protocol configuration options (ePCO) information elements (IEs); and
perform a procedure by transmitting an ePCO information element (IE) to a second network entity via one or more of the network entities identified in the list of identities.

2. The UE of claim 1, wherein the UE uses a parameter in a radio resource control (RRC) message to indicate at least one identity from the list of identities for performing the procedure.

3. The UE of claim 1, wherein the second signaling includes the indication of the list of identities based on the first network entity being incapable of processing ePCO IEs.

4. The UE of claim 1, wherein the second signaling is received from the second network entity via the first network entity.

5. The UE of claim 1, wherein the ePCO IE includes a message, the message including one or more IEs for triggering a policy association.

6. The UE of claim 1, wherein the attach request includes a protocol configuration options (PCO) IE, the PCO IE including a container having an identity, the identity indicating that the UE is capable of receiving user equipment route selection policy (URSP) in an evolved packet system (EPS) network.

7. The UE of claim 1, wherein the second signaling includes a protocol configuration options (PCO) IE from the second network entity, the PCO IE including a container indicating the list of identities.

8. The UE of claim 1, wherein the procedure is a tracking area update procedure.

9. The UE of claim 1, wherein the first network entity is a mobility management entity.

10. The UE of claim 1, wherein the second network entity is a session and mobility management function packet data network gateway controller (SM+PGW-C).

11. The UE of claim 1, wherein the list of identities includes identities of one or more mobility management entities capable of processing the ePCO IEs.

12. (canceled)

13. (canceled)

14. (canceled)

15. (Canceled)

16. (canceled)

17. (canceled)

18. (canceled)

19. A first network entity for wireless communication, comprising:
at least one memory; and
at least one processor coupled with the at least one memory and operable to cause the first network entity to:
receive, from a user equipment (UE), a first signaling indicating an attach request;
transmit, to a second network entity, a second signaling as a create session request message based on the attach request;
receive, from the second network entity, a third signaling that includes an indication of a list of identities of network entities capable of processing extended policy configuration options (ePCO) information elements (IEs); and
transmit, for receipt at the UE, a fourth signaling indicating the list of identities.

20. A method performed by a user equipment (UE), the method comprising:
transmitting, to a first network entity, a first signaling indicating an attach request;
receiving a second signaling in response to transmitting the first signaling, the second signaling including an indication of a list of identities of network entities capable of processing extended protocol configuration options (ePCO) information elements (IEs); and
performing a procedure by transmitting an ePCO information element (IE) to a second network entity via one or more of the network entities identified in the list of identities.

21. The method of claim 20, further comprising using a parameter in a radio resource control (RRC) message to indicate at least one identity from the list of identities for performing the procedure.

22. The method of claim 20, wherein the second signaling includes the indication of the list of identities based on the first network entity being incapable of processing ePCO IEs.

23. The method of claim 20, wherein the ePCO IE includes a message, the message including one or more IEs for triggering a policy association.

24. The method of claim 20, wherein the attach request includes a protocol configuration options (PCO) IE, the PCO IE including a container having an identity, the identity indicating that the UE is capable of receiving user equipment route selection policy (URSP) in an evolved packet system (EPS) network.

25. The method of claim 20, wherein the second signaling includes a protocol configuration options (PCO) IE from the second network entity, the PCO IE including a container indicating the list of identities.

26. The method of claim 20, wherein the procedure is a tracking area update procedure.

27. A method performed by a first network entity, the method comprising:
receiving, from a user equipment (UE), a first signaling indicating an attach request;
transmitting, to a second network entity, a second signaling as a create session request message based on the attach request;
receiving, from the second network entity, a third signaling that includes an indication of a list of identities of network entities capable of processing extended policy configuration options (ePCO) information elements (IEs); and
transmitting, for receipt at the UE, a fourth signaling indicating the list of identities.
